(19) United States
(12) Patent Application Publication
(10) Pub. No.: US 2024/0090553 A1
(43) Pub. Date: Mar. 21, 2024

(54) High Protein, Low Carbohydrate Gummies

(71) Applicant: Michael Segrest, Key West, FL (US)

(72) Inventor: Michael Segrest, Key West, FL (US)

(21) Appl. No.: 17/945,630

(22) Filed: Sep. 15, 2022

(51) Int. Cl. A23L 29/281; A23L 33/15; A23L 33/16; A23L 33/26

(52) U.S. Cl. CPC A23L 29/284; A23L 33/15; A23L 33/16; A23L 33/26

(57) ABSTRACT

A gummy composition comprising at least 46 percent by weight of the composition of a protein, wherein at least a portion of the protein is hydrolized. A composition can include 47-57 grams protein-based gelatin; 28-43 grams water; 1-5 grams citric acid; and 0.05-0.2 grams potassium sorbate as a preservative. The protein-based gelatin can provide high protein content for macronutrient density while at the same time allowing the physical structure of the chewable gummy to maintain a balance between pleasurable palate feel (i.e., texture) and resistance to deformation (in particular, deformation due to heat, for example).

### BACKGROUND OF THE INVENTION

### 1. Field of Invention

The present invention pertains generally to nutritional products and, more particularly, to chewable gummy products.

### 2. Description of the Related Art

Chewable gummy products are generally made of a gelatin or pectin matrix with sugar, glucose or corn syrup, flavoring, coloring, and citric acid. The gummy product typically has a gel or gel-like structure and texture and is produced in a variety of shapes, colors and flavors that are chewable when consumed. Recently, gummy products have been supplemented with vitamins, minerals, and/or fiber.

For example, U.S. Pat. No. 11,350,657 discloses gummy composition including: 10 to 45 percent by weight of the composition of a protein, wherein a portion of the protein is hydrolyzed; maltitol syrup; sugar; a structurant; and water. A method of manufacture of a gummy composition including: Forming a mixture comprising 10 to 45 percent by weight of the composition of a protein, maltitol syrup, sugar, a structurant and water, wherein a portion of the protein is hydrolyzed; and cooking the mixture at a temperature of 85° C. or less.

A need is still felt for high protein gummy formulas that are capable of functioning as a high protein source. Historically, issues associated with protein gummies generally include their color stability, texture, flavor, and limited shelf life.

### SUMMARY OF THE INVENTION

Disclosed herein are various example embodiments of the present general inventive concept.

Thus, in some example embodiments of the present general inventive concept, a gummy composition that is at least 46 percent protein by weight of the includes a high-protein gelatin, water, citric acid, and potassium sorbate as a preservative. The protein-based gelatin provides high protein content for macronutrient density and at the same time allows the physical structure of the chewable gummy to maintain a balance between pleasurable palate feel and resistance to deformation. The water works in conjunction with the gelatin to maintain the structure of the gummy composition. Citric acid gives the gummy a desired sour taste; citric acid also reduces the pH of the overall mixture, enhancing the capacity of the potassium sorbate to inhibit microbial buildup and/or fungal buildup within the gummy composition.

Optionally, in some example embodiments, the gummy composition also includes one or more of the following: a sweetener, such as sucralose or some artificial sweetener; artificial flavor; artificial color; and one or more supplements, such as vitamins, minerals, fiber, or some other dietary supplement.

In some example embodiments of the present general inventive concept, a gummy composition comprises at least 46 percent by weight of the composition of a protein, wherein a portion of the protein is hydrolized; citric acid; potassium sorbate; and sweetener.

### FIGURES

The above-mentioned and additional features of the invention will become more clearly understood from the following detailed description of the invention read together with the drawings in which:

FIG. 1 is a flow diagram illustrating one example embodiment of a method or process according to the present general inventive concept.

### DETAILED DESCRIPTION

Generally speaking, gummy compositions according to various example embodiments of the present general inventive concept include at least 46 percent by weight of the composition of a protein, wherein a portion of the protein is hydrolized.

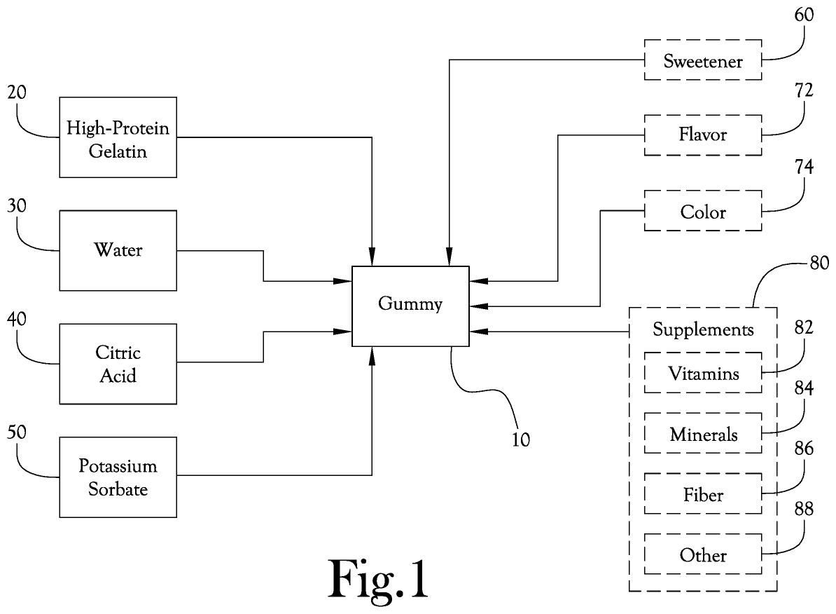

Turning to the FIGURE, FIG. 1 shows a flow diagram illustrating in general terms one example embodiment of a high-protein gummy according to the present general inventive concept, showing the components of the aforementioned gummy composition. As shown in FIG. 1, a gummy composition 10 includes a high-protein gelatin 20, water 30, citric acid 40, and potassium sorbate 50 as a preservative. Optionally, in some example embodiments, the gummy composition 10 also includes one or more of the following: a sweetener 60, such as sucralose or some artificial sweetener; artificial flavor 72; artificial color 74; and one or more supplements 80, such as vitamins 82, minerals 84, fiber 86, or some other dietary supplement 88. The protein-based gelatin 20 provides high protein content for macronutrient density and at the same time allows the physical structure of the chewable gummy to maintain a balance between pleasurable palate feel and resistance to deformation. The water 30 works in conjunction with the gelatin 20 to maintain the structure of the gummy composition 10. Citric acid 40 gives the gummy 10 a desired sour taste; citric acid 40 also reduces the pH of the overall mixture, enhancing the capacity of the potassium sorbate 50 to inhibit microbial buildup and/or fungal buildup within the gummy 10.

In one embodiment, a gummy composition includes 47-57 grams protein-based gelatin; 28-43 grams water; 1-5 grams citric acid; and 0.05-0.2 grams potassium sorbate as a preservative. The protein-based gelatin provides high protein content for macronutrient density while at the same time allowing the physical structure of the chewable gummy to maintain a balance between pleasurable palate feel (i.e., texture) and resistance to deformation (in particular, deformation due to heat, for example). The water works in conjunction with the gelatin to maintain the gummy's structure. Citric acid gives the gummy a desired sour taste; additionally, the citric acid reduces the pH of the overall mixture, which enhances the ability of the potassium sorbate preservative to inhibit microbial buildup and/or fungal buildup within the gummy end product. Potassium sorbate, acting as a preservative, enhances the shelf life of the gummy end product and moreover inhibits microbial buildup and/or fungal buildup within the gummy end product. Optionally, the gummy composition also includes up to 2 grams of sucralose or some other artificial sweetener. The use of artificial sweetener eliminates the need for sugar or syrup within the gummy composition, reducing the overall calorie content of the gummy end product and helping to minimize the carbohydrate content of the gummy end product. Optionally, the gummy composition also may include natural or artificial flavoring; natural or artificial colors; and one or more vitamin and/or mineral supplements.

Table 1 presents a formulation for an example embodiment of a high-protein gummy according to the present general inventive concept:

TABLE 1

| Component | Approximate Mass Range | |
|---|---|---|
| Protein-based Gelatin | 47-57 | g |
| Water | 28-43 | g |
| Citric Acid | 1.0-5.0 | g |
| Potassium Sorbate | 0.05-0.2 | g |
| Sweetener (optional) | 0-2.0 | g |
| Flavoring (optional) | 0-1.0 | g |
| Coloring (optional) | 0-1.0 | g |
| Supplement (optional) | 0-3.0 | g |

Various example embodiments of the present general inventive concept provide a gummy composition that includes at least 46 percent by weight of the composition of a protein, wherein a portion of the protein is hydrolized.

Example embodiments of the present general inventive concept provide high protein gummy formulas that are capable of functioning as a high protein source. High-protein gummies according to example embodiments of the present general inventive concept generally exhibit improved color stability, texture, flavor, and shelf life compared to the prior art.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Moreover, in the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, FIGURE, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the detailed description are hereby expressly incorporated into this detailed description, with each claim standing on its own as a separate embodiment of the invention.

What is claimed is:

1. A gummy composition comprising:
at least 46 percent by weight of the composition of a protein, wherein a portion of the protein is hydrolized;
citric acid;
potassium sorbate; and
sweetener.

2. The gummy composition of claim 1 further comprising artificial flavoring.

3. The gummy composition of claim 1 further comprising artificial coloring.

4. The gummy composition of claim 1 wherein the sweetener includes sucralose.

5. The gummy composition of claim 1 wherein the sweetener includes artificial sweetener.

6. The gummy composition of claim 1 further comprising at least one vitamin supplement.

7. The gummy composition of claim 1 further comprising at least one mineral supplement.
